(19) United States
(12) Patent Application Publication
(10) Pub. No.: US 2009/0040974 A1
(43) Pub. Date: Feb. 12, 2009

(54) COMBINING TRANSMISSIONS OF DIFFERENT PROTOCOLS IN A WIRELESS COMMUNICATIONS

(75) Inventor: Mariana GOLDHAMER, Ramat Gan (IL)

Correspondence Address: BROWDY AND NEIMARK, P.L.L.C.;624 NINTH STREET, NW, SUITE 300, WASHINGTON, DC, 20001-5303, US

(73) Assignee: Alvarion Ltd., Tel-Aviv (IL)

(21) Appl. No.: 12/170,279

(22) Filed: Jul. 9, 2008

(30) Foreign Application Priority Data
Jul. 9, 2007 (IL) 184490

(51) Int. Cl. H04W 4/00

(52) U.S. Cl. 370/329; 370/466

(57) ABSTRACT

A method and devices for allowing communications between a central station and subscriber terminals along a frequency channel in a wireless network comprising a central station and a plurality of subscriber terminals, out of which at least one uses a scheduled based protocol. The method comprises: providing a plurality of time domain frames each comprising at least one first time interval for implementing schedule based protocol, and at least one second time interval for implementing a contention based protocol; scheduling a plurality of unconditioned transmissions in a plurality of present and/or future frames during the first time interval of corresponding time domain frames to/from the subscriber terminal(s) operating under the schedule based protocol; scheduling a plurality of conditioned transmission opportunities in a plurality of present and/or future frames during the second time interval of corresponding time domain frames to/from the terminals operating under the schedule based protocol; determining, prior to sending a conditioned transmission, whether the value of received power level is below a pre-defined threshold value and transmitting communications during the second time interval upon determining that this value does not exceed a pre-defined threshold.

### FIELD OF THE INVENTION

The present invention relates generally to wireless communications, and in particular, to wireless networks that allow sharing of the frequency spectrum by different types of transmission technologies.

### BACKGROUND OF THE INVENTION

The use of various wireless access technologies has been experiencing rapid growth in the recent years which leads to the congestion of the already allocated spectrum, as happened in 2.4 GHz which is extensively used by WiFi systems. There are no licenses fees associated with the usage of the 2.4 GHz spectrum, so that wireless networks can be deployed to satisfy a high variety of applications. However, systems deployed in such a frequency spectrum may experience a strong interference which will degrade the systems' performance and ability to support the target applications.

In the wireless world, two of the major transmission methods have been defined and can be understood by considering for example recommendations drawn by the IEEE 802.16 committee and by the IEEE 802.11 committee. The basic difference between these two methods can be summarized by the fact that while the 802.16 recommendation is directed to scheduled uplink and downlink transmissions and to the prevention of collisions between transmissions, the 8023.11 recommendation is directed to a contention type of transmissions, in which there is a competition for resources when two or more transmitters attempt to send a message at the same time.

The 802.11 based systems use a protocol named “listen before talk”, in which a transmission is deferred until the medium becomes available. If the transmitted packets are not properly received, the access to the medium is attempted during a “Contention window” which becomes exponentially longer as sequential transmissions fail to be adequately received.

The fundamental access method implemented by the IEEE 802.11 MAC is a method characterized as being of a bursty type and which can be referred to as a carrier sense multiple access with collision avoidance (CSMA/CA). It may be implemented in the various stations, where a station (STA) is defined as any device that contains an IEEE 802.11-conformant medium access control (MAC) and physical layer (PHY) interface to the wireless medium. For a STA to be able to transmit, it has first to sense the medium in order to determine if another STA is transmitting (hence “listen before talk”). If the medium is not determined to be busy, the transmitting process may proceed. A transmitting STA should ensure that the medium is idle for the required duration before attempting to transmit. In the case that the medium is determined to be busy, the STA shall defer from transmission until the end of the current transmission. After deferral, or prior to attempting to transmit again immediately after a successful transmission, the STA selects a random back-off interval and decrements the back-off interval counter while the medium is idle. FIG. 1 is a prior art illustration of operation under the IEEE 802.11 protocol.

It is now desired that more 802.16 based systems will be able to share the frequency spectrum and even to share a frequency channel. The obvious approach for such implementation is to keep the scheduled character of 802.16 and to sub-divide a channel in the time domain for resolving the interference problem. Therefore, the 802.16h committee has defined a “Coexistence Frame” or CX Frame in which up to three systems can share a frequency channel in a coordinated mode, by which each system schedules its communications according to the general 802.16 scheduled approach.

The US Federal Communication Committee (FCC) has decided to make available new spectrum in 3.65-3.70 GHz for shared usage, while requesting that systems using this frequency spectrum implement a protocol which can reduce the co-frequency interference with devices using all other types of contention-based protocols. In other words, an 802.16 system needs to be able to share the channel not only with other 802.16 systems, but also with other types of systems (e.g. 802.11) and vice versa.

In order to define an un-restricted contention-based protocol and also to increase the efficiency of bandwidth utilization in such networks, it would be desired to allow sharing of a frequency channel between bursty type of systems and scheduled type of systems, but the obvious problem is how to combine successfully these two so different types of operation.

### SUMMARY OF THE INVENTION

It is therefore an object of the present invention to provide a method and apparatus to enable combining contention-based systems with scheduled systems, while sharing the frequency spectrum and possibly sharing a frequency channel while minimizing possible interference between transmitters operating in accordance with the various protocols.

It is another object of the present invention to provide a method and apparatus to enable a scheduled system to behave as a contention-based system, while preserving its fundamental scheduled character.

It is a further object of the present invention to provide a method and apparatus to preserve the QoS (quality of service) and large cell size of the scheduled systems while using efficiently the available frequency spectrum resource.

It is still another object of the present invention to provide a method and apparatus to enable flexible resources' allocations between transmissions utilizing different technologies.

Other objects of the invention will become apparent as the description of the invention proceeds.

One of the main issues addressed by the solution proposed by the present invention is how to provide scheduled transmission opportunities which are adapted to follow the rules of a contention-based protocol, such as for example “listen-before-talk” and “logarithmic back-off”, and others.

Therefore, according to an embodiment of the present invention, there is provided in a wireless communications network comprising at least one central station and a plurality of subscriber terminals associated therewith, out of which at least one of the subscriber terminals is operative to communicate by using a scheduled based protocol, a method for allowing communications between at least one central station and at least one subscriber terminal along a frequency communication channel, wherein the method comprises the steps of:

providing a plurality of time domain frames each comprising at least one first time interval adapted for communication with a subscriber terminal by applying a schedule based protocol, and at least one second time interval adapted for communication with a subscriber terminal by applying a contention based protocol;

scheduling a plurality of unconditioned transmissions for sending communications in a plurality of present and/or future frames during the first time interval of corresponding time domain frames to/from at least one subscriber terminal operative in accordance with the schedule based protocol;

scheduling a plurality of conditioned transmission opportunities for sending communications in a plurality of present and/or future frames during the second time interval of corresponding time domain frames to/from at least one subscriber terminal operative in accordance with the scheduled based protocol;

determining, prior to sending a conditioned transmission in at least one second time interval of the at least one of the future frames, whether the value of received power level at that frequency communication channel is below a pre-defined threshold value; and

transmitting communications during the second time interval upon determining that the value of the received power level at that frequency communication channel does not exceed the value of a pre-defined threshold.

The term “schedule based protocol” as used herein throughout the specification and claims, is used to denote a method of transmission/reception whereby both uplink and downlink transmissions may be carried out only in time intervals that have been allocated to transmission of information by the central station or by a specific subscriber terminal. In a broader sense, the term scheduling may be considered as referring to partitions in time, frequency and space domains.

The term “contention based protocol” as used herein throughout the specification and claims, is used to denote a method of transmission/reception whereby two or more radio stations try to use the medium to transmit. In case that the downlink and uplink transmissions are coordinated, a central station may compete with another central station or a subscriber station may compete with another subscriber station. In case that mixed 802.11 systems and scheduled systems use a “contention based protocol” the central stations and subscriber stations may also compete with each other. Such a method typically relies on the “listen before talk” rule by which each subscriber terminal awaits before sending the transmission until the medium becomes available. If the medium is determined to be busy, the subscriber terminal defers from transmission until the end of transmission that is currently being sent by another entity. However, if the transmitted packets are not properly received, an attempt to re-access the medium is made during a “contention window”, where the contention window becomes exponentially longer as sequential transmissions fail to be adequately received. This medium access policy is also named “logarithmic back-off”.

As will be appreciated by those skilled in the art, the first time interval referred to herein, is adapted for use by one or more subscriber terminals operating in accordance with the schedule-based protocol for exchanging un-conditioned transmissions. The term “un-conditioned” as used herein should be understood to refer to the fact that such a transmission will take place irrespective of the status of the medium (whether the medium is busy or available). While operating in accordance with a schedule based protocol, separated sub-frames are allocated for Downlink (DL) transmissions from a central station to the subscriber terminal and for up-link (UL) transmissions from the subscriber terminal to the central station. Therefore, un-conditioned transmissions are the communications that are sent during the first (scheduled) interval, and are carried out when scheduled, irrespective of the power level at the receiver.

The second time interval referred to herein, is adapted for use by one or more subscriber terminals operating in accordance with the contention based protocol for exchanging conditioned transmissions. Typically, there is no differentiation between DL or UL transmissions in allocating the network resources. The conditioned transmissions are communications that are scheduled for transmission during the second (bursty) interval, preferably using the “listen before talk” rule as a pre-condition for transmission together with logarithmic back-off mechanism as the scheduling policy.

A frame combining these two types of intervals is also referred to herein as a “Coexistence Frame”, and this frame structure repeats itself in the time domain.

The term “central station” is used herein to encompass any entity operative to convey transmissions to a number of other entities to which it is communicatingly connected. Such central station can be a Base Station, a Relay and the like.

The term “subscriber terminal” as used herein is used to denote an entity that is adapted to communicate with a central station such as a subscriber station, a mobile station, user equipment, customer premises equipment (CPE), a relay station, and the like.

According to a preferred embodiment of the invention, the at least one subscriber terminal is adapted to transmit unconditioned transmissions during the first time interval and conditioned transmissions during the second time interval.

In accordance with still another preferred embodiment of the invention, the method provided further comprises the step of selecting at least one of the plurality of conditioned transmission opportunities for transmission of communications during a second time interval in at least one of the plurality of present and/or future frames. Preferably, earlier opportunities are the preferred ones.

By yet another embodiment of the invention, the method provided further comprises a step of determining whether additional transmission time would be required after having transmitted at least one communication message, and if in the affirmative, selecting another of the plurality of conditioned transmission opportunities for transmission of a communication message during a second time interval in at least one of the plurality of present and/or future frames.

As will be appreciated by those skilled in the art, this process of sending conditioned transmissions referred to hereinabove, may be repeated as long as further transmission time is required.

In accordance with yet another embodiment of the invention, the step of scheduling a plurality of conditioned transmission opportunities comprises defining a starting point for conditioned transmissions using a random moment during a period of time referred to as “contention window”. Preferably, the duration of such a contention window is determined based on the back-off policy implemented in accordance with the contention based protocol applied (e.g. exponential or based on any other applicable rule). The minimum interval between such starting points is consistent with the technology applied).

In addition or in the alternative, the starting point for possible transmission opportunities is selected so that it is in compliance with the rules of downlink/up-link sub-frames applicable to synchronized transmissions, or any other relevant rule. As will be appreciated by those skilled in the art, the invention encompasses synchronized and scheduled transmissions for which a precise point in time is defined as their starting point, as well as cases where a subscriber terminal is instructed to start and/or finish its transmission during a DL or UL sub-frame, without specifying such a precise point in time. In other words, the present invention should be understood to encompass also cases where the transmissions are synchronized with DL/UL periods, but are not precisely scheduled.

By still another preferred embodiment, the transmission duration is determined for every conditioned transmission opportunity, and preferably this determination is made in compliance with rules of downlink/uplink synchronized transmissions or any other relevant rule.

As can be appreciated by those skilled in the art, the mechanism suggested herein by the present invention allows also for transmissions of the scheduled based protocol (e.g. 802.16 sub-frames or slots of any other scheduled based protocol) to be used in a contention-based mode during contention-based intervals.

In accordance with still another preferred embodiment of the invention, the method provided further comprising a step of increasing the length of the contention window and/or delaying the beginning of the contention window, in response to an un-successful attempt to transmit a message (i.e. to communicate). The delay can be for example by at least one downlink or uplink sub-frame.

According to another embodiment of this aspect of the invention, the value of the pre-defined threshold is determined and/or modified by the central station or by an entity external to the system. In addition or in the alternative, the value of the pre-defined threshold is determined/modified based on a decision made by the at least one central station and/or a management station and/or the respective subscriber terminal in order to adapt this value to the current channel interference conditions.

In accordance with still another preferred embodiment, the duration of the contention window may be selected in a way to provide priority for transmissions using the contention-based protocol as their primary media access protocol.

According to another aspect of the invention, there is provided a central station operative in a wireless communications network which comprises a plurality of subscriber terminals, out of which at least one subscriber terminal is operative to communicate with the central station by using a schedule based protocol, and wherein the central station comprises:

at least one radio transceiver operative at lest one frequency and capable of transmitting and/or receiving both conditioned and un-conditioned transmissions along a frequency communication channel to/from the at least one terminal;

at least one processor adapted to schedule a plurality of conditioned and un-conditioned transmission and/or reception opportunities for communications in a plurality of future frames, to select at least one of the plurality of conditioned transmission opportunities in at least one of the plurality of future frames for sending communications to the at least one subscriber terminal operative according to a schedule based protocol, to receive an input from energy level detection means as to the energy level in the respective frequency communication channel, to determine whether the energy level at that communication channel exceeds the value of a pre-defined threshold, and to enable transmissions to that at least one subscriber terminal along the respective communication channel if the energy level input does not exceed a pre-defined threshold value; and

energy level detection means operative to detect the energy level at that frequency communication channel along which communications are about to be transmitted, and to provide the value of the energy level detected to the at least one processor.

According to another embodiment of the invention the at least one processor comprised in the central station is further adapted to select at least one of the plurality of conditioned transmission opportunities for transmission of communications during a second time interval in at least one of the plurality of present and/or future frames. Preferably, the earlier opportunities are the preferred ones.

By still another preferred embodiment, the at lest one processor comprised in the central station is further adapted to determine whether additional transmission time would be required after transmission of at least one communication message, and if in the affirmative, to select another of the plurality of conditioned transmission opportunities for transmission of a communication message during a second time interval in at least one of the plurality of present and/or future frames.

According to a preferred embodiment of this aspect of the invention the at least one subscriber terminal is operative to communicate with the central station by using a schedule-based protocol, while transmitting/receiving both un-conditioned and conditioned communication, at the appropriate time interval.

According to another preferred embodiment of the invention, the processor is further operative to determine a starting point for possible communication transmissions and/or receptions using a random point in time during a time interval (“contention window”) such that at least one subscriber terminal communicates by using a contention based protocol. Preferably, the duration of such a contention window is determined based on the back-off policy implemented in accordance with the contention based protocol applied (e.g. exponential duration increase or based on any other applicable rule).

In addition or in the alternative, the starting point for possible communication transmissions is selected by the processor so that the selection is in compliance with the rules of downlink/uplink sub-frames applicable to synchronized transmissions, or any other relevant rule.

According to still another embodiment of this aspect of the invention, the pre-defined threshold is provided externally to the central station. In addition or in the alternative, the value of the pre-defined threshold is determined/modified by the central station processor in order to adapt this value to the current channel interference conditions.

In accordance with still another preferred embodiment, the duration of the contention window is selected by the processor so as to provide priority for transmissions using contention-based protocol as their primary media access protocol.

By yet another aspect of the invention there is provided a subscriber terminal operative in a wireless communications network to communicate with a central station by using schedule based protocol for transmitting and/or receiving both un-conditioned and conditioned transmissions, and wherein the subscriber terminal comprises:

at least one radio transceiver operative at least one frequency and capable of transmitting communication traffic towards the central station and receive communication traffic therefrom;
at least one processor adapted to:
receive information related to scheduling of a plurality of unconditioned transmissions for sending scheduled communications in at least one first time interval associated with a plurality of present and/or future frames;
receive information related to scheduling of a plurality of conditioned transmission opportunities for sending communications in at least one second time interval associated with a plurality of present and/or future frames;
select at least one out of the plurality of conditioned transmission opportunities,
receive an input from received power level detection means as to the received power level in the respective communication channel,
determine whether the received power level at that communication channel exceeds the value of a pre-defined threshold;
enable transmissions to the central station along the respective frequency communication channel if the energy level input does not exceed the pre-defined threshold value; and

received power level detection means operative to detect the received power level at the respective frequency communication channel along which communications are about to be transmitted, and to provide the value of the received power level detected to the at least one processor.

According to another embodiment of the invention the at least one processor comprised in the subscriber terminal is further adapted to select at least one of the plurality of conditioned transmission opportunities for transmission of communications during a second time interval in at least one of the plurality of present and/or future frames. Preferably, the earlier opportunities are the preferred ones.

By still another preferred embodiment, the at least one processor comprised in the subscriber terminal is further adapted to determine whether additional transmission time would be required after transmission of at least one communication message, and if in the affirmative, to select another of the plurality of conditioned transmission opportunities for transmission of a communication message during a second time interval in at least one of the plurality of present and/or future frames.

### BRIEF DESCRIPTION OF THE DRAWINGS

FIG. 1—illustrates prior art mode of operation under the IEEE 802.11 protocol;

FIG. 2—presents a schematic illustration of down-link and up-link CX frame;

FIG. 3—illustrates a schematic presentation of scheduled downlink “listen before talk” opportunities in a CXCW; and

FIG. 4—illustrates a schematic presentation of scheduled uplink “listen before talk” opportunities in a CXCW.

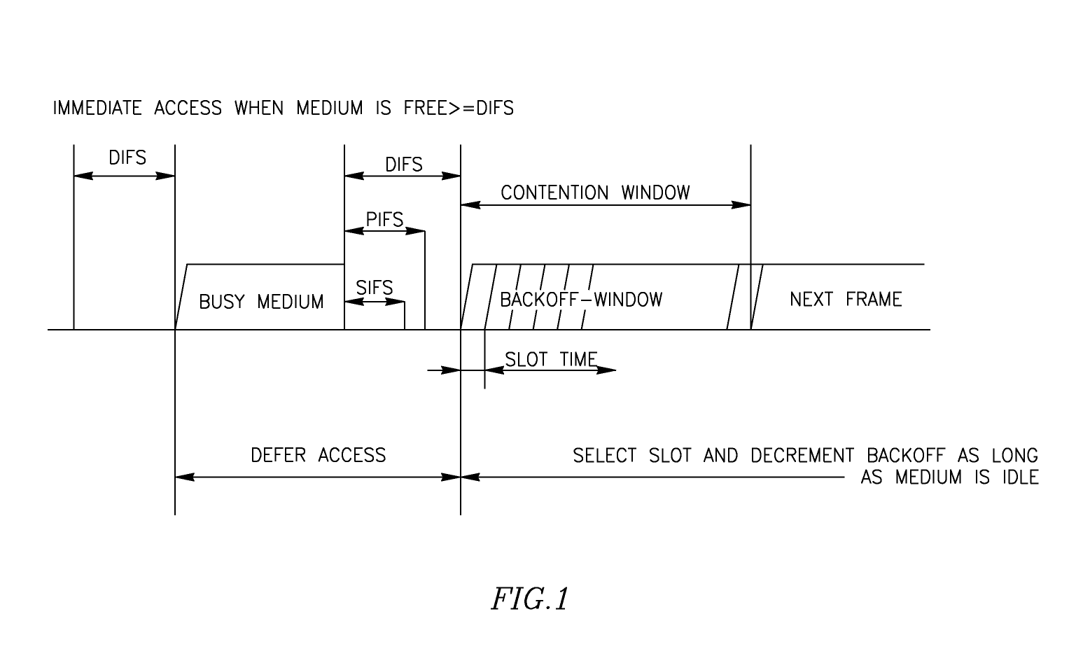

### DETAILED DESCRIPTION OF THE INVENTION

A better understanding of the present invention may be obtained when the following non-limiting detailed description is considered in conjunction with the following drawings.

The examples that will be discussed herein below relate primarily to the minimum requirements for using 802.11-based contention protocol while avoiding interference from the use of subscriber terminals using 802.16-based Coordinated Coexistence Protocol (CXP) and enhancements to the 802.16h coordinated approach to optimally share the spectrum with 802.11-based contention protocols that are suitable to operate as un-restricted contention-based protocols.

These enhancements are made to confirm that the cell size as well as the quality of service (QoS), as achieved while using the 802.16 protocol, is maintained during intervals allocated for usage by systems which adapt scheduling as their primary media access mode.

Thus, according to the following examples, the 802.16-based transmissions are exchanged during the “scheduled-based interval” while using the 802.16 scheduled approach, whereas 802.11 transmissions are exchanged during the “contention-based interval” while using the 802.11 contention-based protocol.

In such a mixed network 802.16 and 802.11 users can use the “contention-based interval”, according to their traffic demands. The 802.11 users have priority to operate in the “contention-based interval”, but if the available bandwidth is not fully used by 802.11 users, the 802.16 users will be able to operate.

This way, the 802.16 users would not create interference and will provide transmit opportunities to the 802.11 users and vice versa, the 802.11 users would not create interference to the 802.16 users and the 802.16 users will have opportunities to transmit during extended periods of time.

Preferably, the minimum requirements for allowing bursty technologies avoiding to create interference to 802.16h systems using the Coordinated Coexistence (CX) are:

1) Synchronization with the start of the CX Frame; and
2) Separation in time between the CX Frame sub-frames dedicated to scheduled protocols (802.16) and contention-based protocols, according to the rules presented below.
Synchronization with the Start of the CX-Frame:

There are a number of ways to synchronize an 802.11 AP (Access Point) with the start of the 802.16 CX-Frame, among which are:

GPS synchronization, based on the absolute time;

Network Time synchronization, based on the absolute time;

Synchronization with the CX Control Channel (CXCC), using simple cognitive radio procedures, and the like.

The 802.11 stations may be further synchronized to Access Points using regular 802.11 procedures.

### Separation in Time of the Technologies:

In order to allow a simple operation for a mix of 802.16 and 802.11 systems in a frequency channel, a simple separation of the technologies in time is preferred.

An 802.16h system detects the existence of 802.11y systems in the band based on measurements during the CXCC (Coexistence Control Channel) allocations dedicated to assessment of interference created by non-802.16h systems.

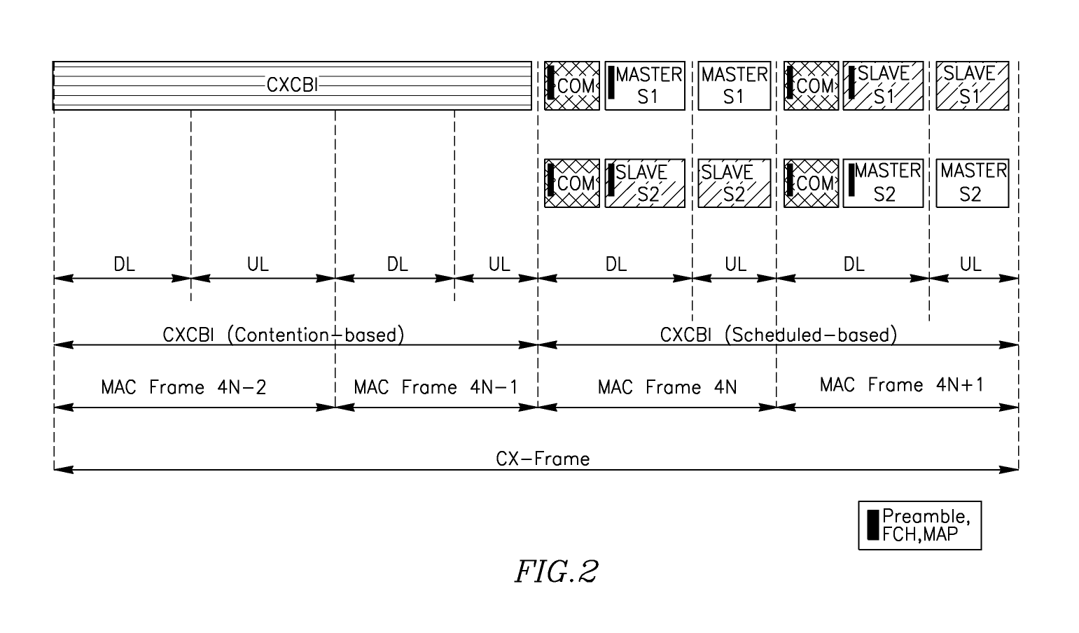

The synchronized and scheduled approach proposed by the present invention for interference avoidance is based on the CX Frame shown in FIG. 2, where two 802.16h systems can share a frequency channel in the case that a bursty system is detected.

In this FIG. 2 (as well as in the following Figs.) the MAC Frames 4N and 4N+1 are dedicated to transmissions according to the schedule based protocol. Every MAC Frame has a DL sub-frame and an UL sub-frame. During the DL sub-frame two other sub-frames may be defined: the Common (Com) and the Master or Slave. During the Common interval, every central station is allowed to transmit. During the Master sub-frame the interference is minimized, because the other system, operating at the same time in a Slave mode, is allowed to transmit only if it does not create interference to the Master system.

The CXCBI interval is dedicated to contention-based operation. A bursty system (like those operating in accordance with the 802.11 recommendation) will not be forced to respect the DL/UL synchronization, but a scheduled system should preferably respect it.

The following occupancy rules are used:
MAC Frames 4N and 4N+1 are reserved for scheduled operation and the created time interval is referred to hereinafter as CXSBI (Scheduled-based interval);
MAC Frames 4N+2 and 4N−1 are reserved for bursty operation; the created time interval is referred to hereinafter as CXCBI (Contention-based interval);
The scheduled systems using the channel may use the MAC Frames reserved for bursty operation in a coordinated coexistence contention-based protocol (CXCBP) mode;
The bursty systems using the channel may use the MAC Frames allocated to Master scheduled systems according to Slave rules.

### A. Rules for Operation During CXSBI

A 802.11 system which does not create interference to an 802.16h system using the Coordinated Coexistence needs to comply with the common rules, regarding:
Tx/Rx (downlink/uplink) synchronization
Usage of CXCC
Operational rules defined in 802.16h, section 15.4.2.1.2.

### B. Rules for Operation During the CXCBI Time Interval

Systems operating during the CXCBI intervals will not interfere with the operation of 802.11 based systems. In this case, they will apply a special form of the contention-based protocol as proposed by the present invention and is referred to hereinafter as “Coordinated Coexistence Contention-Based Protocol” or CXCBP, including scheduled “Listen Before Talk” transmission opportunities.

### C. Coordinated Coexistence Contention-Based Protocol

The Coordinated Contention-based Protocol (CXCBP) has the following basic elements:
Frame structure derived from the CX Frame;
Capability to detect 802.11 systems;
Scheduled Listen-before-talk (SLBT) capability;
Contention window and quiet periods;
Logarithmic back-off;
Determination and scheduling of the transmit opportunities;
Longer contention window as compared with 802.11.

### CXCP: Frame Structure for CXCBP

The Coexistence Frame will comprise two synchronized intervals:
Contention-based sub-frame (CXCBI); and
Scheduled-based interval (CXSBI)

This CX Frame structure is illustrated in FIG. 2. As can be seen from this Fig., during CXCBI there are no common sub-frames.

### CXCBP: Detection of Bursty Systems

The detection of bursty (such as 802.11) systems takes place every CX Frame, at the beginning of the CXSBI interval.

During a specified time, referred to as CXBurstyDetectStart and defined as number of CX slots, no 802.16 activity will take place. This will allow the detection with high probability of the bursty systems deployed in the area by either BS or SS/MS. The energy of detecting bursty systems is identical to the energy for CXLBT.

The MAC message conveys the information related to the 802.11 signal power from subscriber terminal to the central station. Based on this information, the central station decides if there are or not bursty systems deployed in the area. If no Bursty system activity is detected for T_Busrty_Detect by a system, that system may use the CXCBI sub-frame as described in IEEE 802.16h section 15.4.2.1.2, which provides the ability for three 802.16h systems to share a frequency channel.

CXBurstyDetectStart is defined as:

CXBurstyDetectStart=2*CXSlotTime(for the OFDMA PHY)

CXBurstyDetectStart=4*CXSlotTime(for the OFDM PHY).

CXBurstyDetectStart includes the RTG interval before a downlink transmission.

The CXSlotTime is equivalent with one OFDM/OFDMA symbol time+the cyclic prefix. This time includes media sensing, Tx/Rx turn-around time, propagation delay and processing delay.

### CXCBP: Scheduled Listen Before Talk (SLBT)

Before any transmission is made, an 802.16 device (central station or subscriber terminal) will check if the media is free.

Preferably, the following rules will apply:

if the media is free for at least CX_LBT_Time [50 us], before the scheduled transmission time of an 802.16 device, the 802.16-based system will start its transmission at the scheduled time;

if the media is busy, the transmission will be deferred until the next scheduled opportunity;

The energy detection level for Listen before Talk may be −75 dBm/10 MHz, or −85 dBm for each MHz of channel bandwidth.

### CXCBP: Transmission Scheduling

The duration of the interval allocated for transmission (CXZ), using the DL/UL MAP allocations, should be suitable for DL/UL sub-frame synchronization.

This condition ensures compatibility with 802.16 MAC and better coexistence between 802.16h systems in case of adjacent areas using CX Frames according to FIG. 2.

For scheduling the traffic in MAC Frames which are beyond the scope of the basic MAC frames, additional DL MAP and UL MAPs are transmitted. These MAPs are transmitted using the CX-DL-MAP and CX-UL-MAP messages, having an enlarged scope and allowing the support of MAC Frames using SLBT.

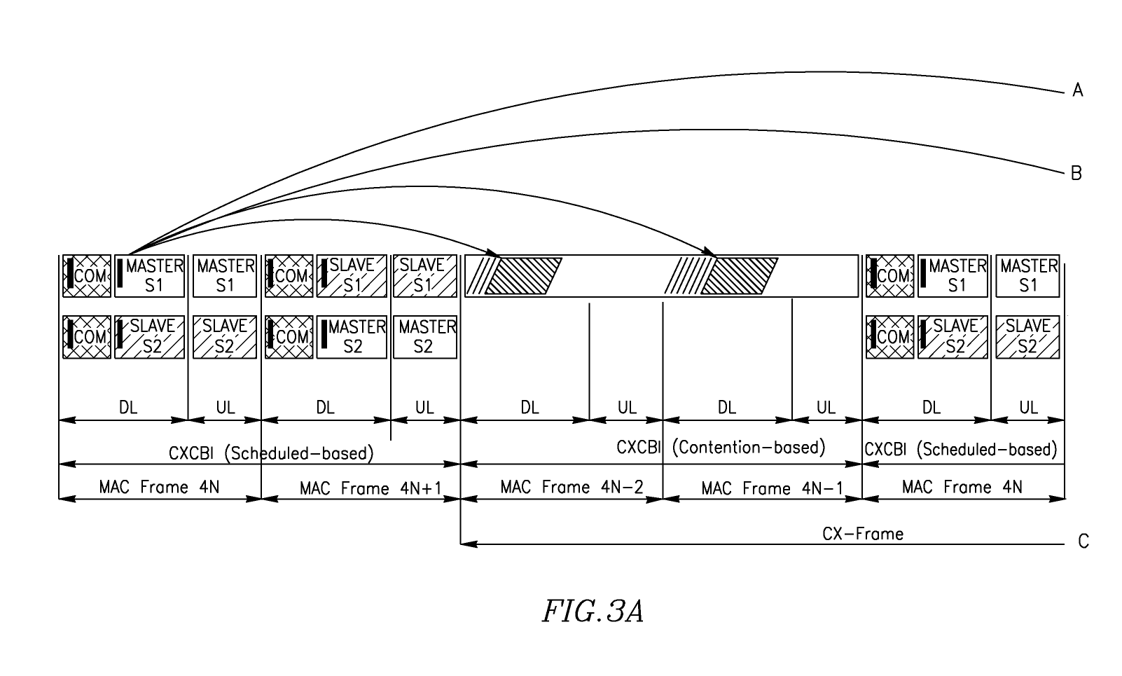

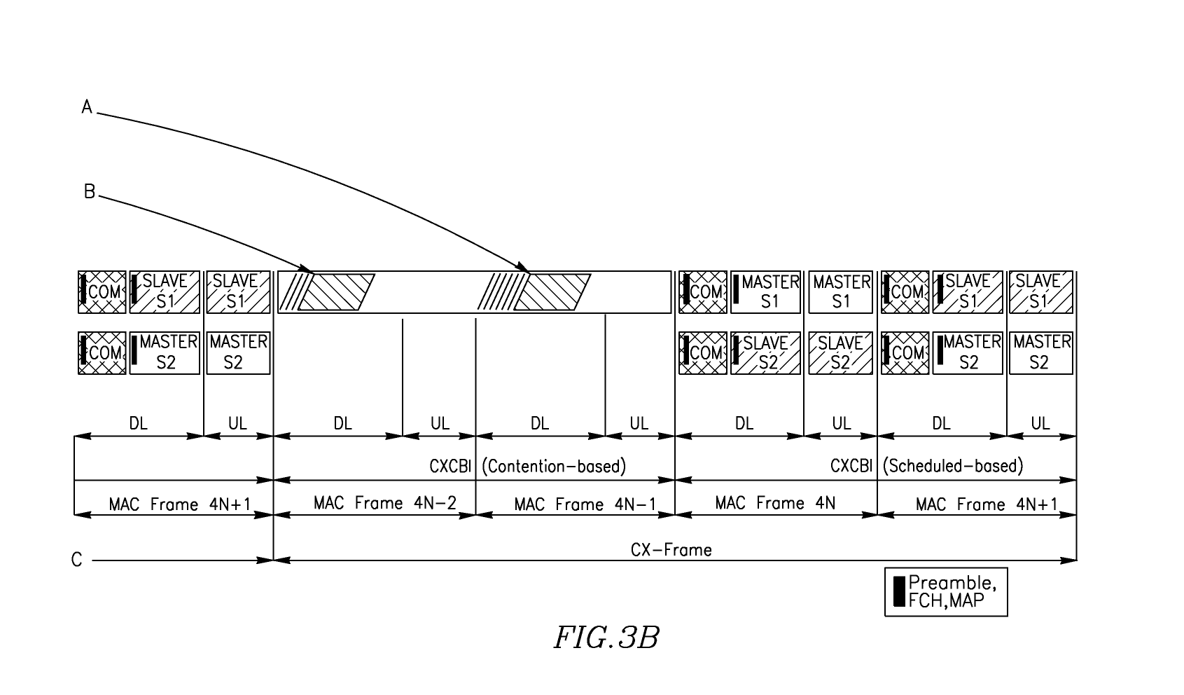

The example illustrated in FIG. 3 is of DL Scheduled Listen Before Talk opportunities in a CXCW. As illustrated in this Fig., during the CXCBI interval, the transmission intervals are preceded by possible moments in time at which the random scheduling is allowed. The start of the conditional transmission opportunity is scheduled in the corresponding possible slot which as randomly chosen. The random process is illustrated in this example by the different number of slots that precede every scheduled transmission opportunity. Due to the fact that the DL transmissions represent an integrated traffic and have a high probability to occur, the scheduling of the slots can cover a higher number of MAC frames.

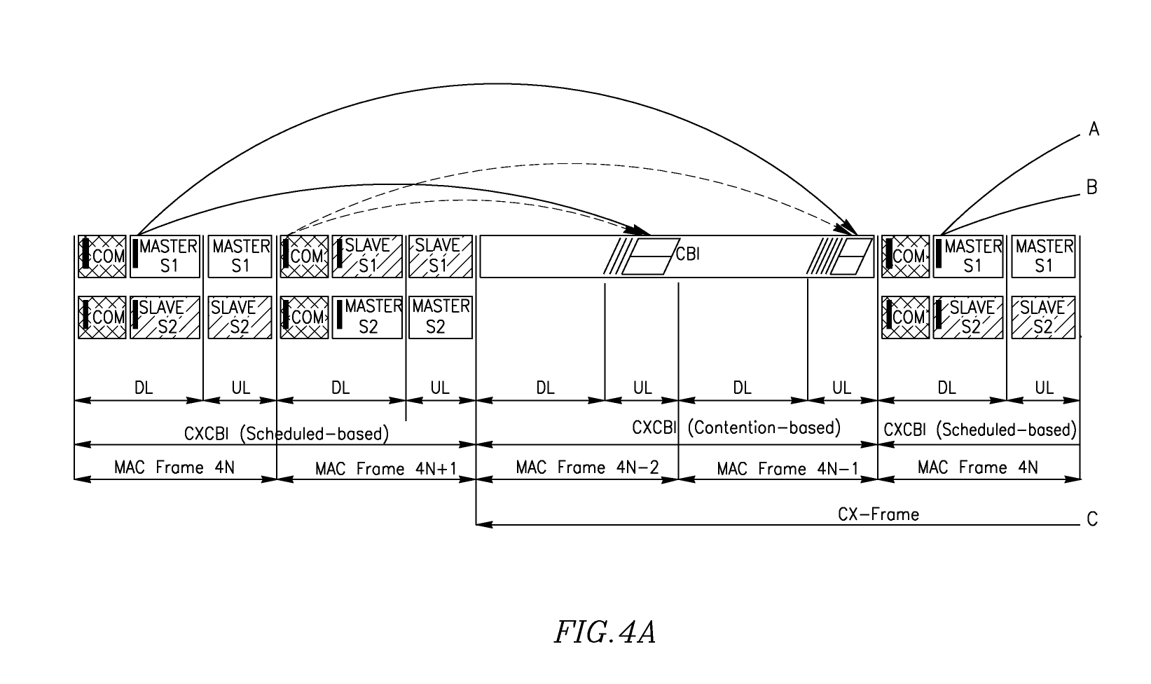

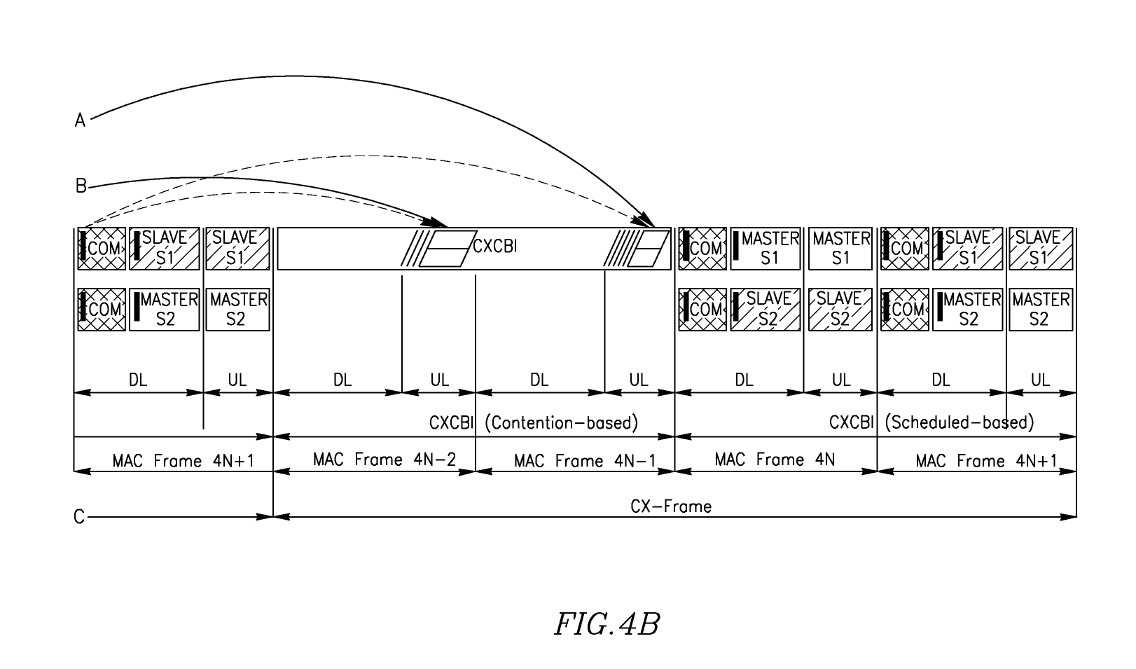

In FIG. 4 an example is shown for UL scheduled “Listen Before Talk” opportunities inside the CXCW. This Fig. is somewhat similar to FIG. 3 mutatis mutandes, but as can be noted, in the example illustrated a shorter range scheduling, has been preferred. The reason being that the up-link traffic for each station depends very much on the instant traffic requirements. The horizontal pattern in the transmission periods is intended to reflect the sub-channelization in the frequency domain, used in the 802.16 recommendation. Different subscriber stations may be scheduled in different preceding MAC Frames, preferably using UL sub-channelization in the frequency domain. In other words, it is preferred to reduce the relevance of the MAP in order to better adapt the transmission opportunities to the actual UL traffic requirements.

### CXCBP: Contention Window

The contention window mechanism enables multiple devices to access the media, while reducing the collisions between themselves.

The contention windows will start after the expiration of the CXBurstyDetectStart interval. The duration of the contention window for a particular 802.16 transmitter is:

CXCWmin=7*CXSlotTime

CXCWmin<CXCW<CXCWmax.

CXCWmax is a system parameter having the CXSlotTime as unit and which is calculated separately for DL and for UL. CXCWmax cannot cover more than 2 CXCBI concatenated intervals.

The transmission opportunity is scheduled during a random slot chosen within the CW. The transmitter will assess if the media is free before the scheduled transmission time, based on CXLBT procedures. FIG. 3 shows the scheduling of transmission opportunities inside the CXCW.

### CXCP: Exponential CXCW and Quiet Periods

In the case of failed receptions, the Base Station (BS) increases the CW for DL or UL traffic in accordance with the following:

CXCW_New=2*CXCW_Old+1,

where CXCW_New is the last slot in the CW after back-off, and CXCW_Old is the last slot of CW before back-off.

CXCWNew<CXCWmax.

The transmission opportunities which do not fall in intervals suitable to DL for central station and UL for subscriber terminal will be excluded.

In case of a successful reception the CXCW that will be used in the next scheduling will be CXCWmin.

In case that more than one CXZ is scheduled during a DL or UL sub-frame, the two zones will be separated by at least one CXSlotTime followed by a CW.

In case that the CW has reached its maximum value and the last transmission was not successfully received, the conditioned transmission opportunities scheduled within first CXCBI are skipped and a Quiet Period is inserted during this interval.

If the next transmission is also un-successful, the next two CXCBI intervals will be considered as Quiet Periods and the next transmission will be scheduled using the maximum contention window only.

The following tables illustrate the DL process of CXCW logarithmic back-off, for a 5 ms OFDMA Frame with 47 symbols, 60% DL, 40% UL including 28 symbols in DL and 19 symbols in UL.

For simplicity, let us assume that the minimum duration of the CXZ is 10 symbols.

Table 1 presents DL valid symbols for the operation of an 802.16 system.

TABLE 1

| | MAC | MAC | | |
|---|---|---|---|---|
| | Frame A | Frame B | MAC Frame C | MAC Frame D |
| CXCBI | 1 | 1 | 2 | 2 |
| visibility | | | | |
| Symbol | 3 . . . 28 | 48 . . . 75 | 96 . . . 121 | 141 . . . 168 |
| (slot) | | | | |
| number | | | | |
| Reserved | 17 . . . 28 | 66 . . . 75 | 112 . . . 121 | 159 . . . 168 |
| slots for | | | | |
| minimum CXZ | | | | |

TABLE 2

| Case | Duration | Range for start of DL CXZ | CXZ |
|---|---|---|---|
| number | of CXCW | (slot number) | duration |
| 1 | 7 | 3 . . . 9, 11 . . . 17, 48 . . . 54, | 26 . . . 20, |
| | | 56 . . . 62, 96 . . . 102, 104 . . . 110, | 18 . . . 10 |
| | | 141 . . . 147, 149 . . . 155 | |
| 2 | 15 | 1 . . . 15, 48 . . . 62, 96 . . . 110, | 28 . . . 14 |
| | | 141 . . . 155 | |
| 3 | 31 | ((3 . . . 17)U (48 . . . 63)), | 26 . . . 12 |
| | | ((96 . . . 112)U(141 . . . 159)) | |
| 4 | 63 | ((3 . . . 17) U | 26 . . . 10 |
| | | (48 . . . 66)U(96 . . . 112)U(141 . . . | |
| | | 158)) (start point for | |
| | | repetitions) | |
| 5 | 63 | (96 . . . 112)U(141 . . . 158) | 26 . . . 10 |
| 6 | 63 | N.A. | 0 |
| 7 | 63 | ((3 . . . 17) U | 26 . . . 10 |
| | | (48 . . . 66)U(96 . . . 112)U(141 . . . | |
| | | 158)) | |

As may be seen from the example provided in the above Table, in cases of high congestion, even when using the maximum contention window, transmission failures might still occur. In order to make the medium available for further transmissions (i.e. to free the medium), the solution offered by the present invention is to introduce silence periods, or in other words, to refrain from scheduling any uplink or downlink transmissions for a given period of time. This mechanism is reflected in lines 5-7 of the above table 2, where the first CXCBI is omitted from the contention window (line 5). In line 6 both CXCBIs are omitted, while in line 7, the longest CW is applied again.

### Determination and Scheduling of Transmit Opportunities

The scheduling of a CXZ during CXCBI will be carried out in accordance with the following:
M (Mdefault=4) next CXCBI intervals are concatenated.
Concatenation should take into consideration the DL and UL intervals synchronization; in this case only the transmission opportunities for central station or subscriber terminal consistent with DL or UL will be used.
The symbols intended for CXBurstyDetectStart at the beginning of each CXCBI are skipped.
The OFDM/OFDMA symbols in the concatenated CXCBI intervals are numbered, according to the rules used in 802.16 (excluding the TTG and RTG intervals).

### MAC Messages in Support of CXCBP

The MAC messages presented hereinbelow serve as an example for possible implementations of scheduling of conditional transmission opportunity.

CX-DL-MAP (DL Map) Message

The CX-DL-MAP message defines the access to the DL information and has an extended scope and flexibility in comparison with the DL-MAP Message. If the length of the CX-DL-MAP message is a non-integral number of bytes, the LEN field in the MAC header is rounded up to the next integral number of bytes. The message is padded to match this length, but the subscriber terminal disregards the 4 pad bits.

The BS generates CX-DL-MAP messages in the format shown in Table 3, including the following parameters:

PHY Synchronization
The PHY synchronization field is dependent on the PHY specification used. The encoding of this field is given in each PHY specification separately.

DCD Count
Matches the value of the configuration change count of the DCD, which describes the DL burst profiles that apply to this map.

Base Station ID
The Base Station ID which is preferably programmable, is a 48-bit long field identifying the BS. The 24 MSBs are used as the operator ID. This is a network management hook that can be sent with the DCD message for handling edge-of-sector and edge-of-cell situations.

DL MAC IE Relevance
This parameter indicates the virtual shift to be added to the MAC Frame number appearing in the subsequent DL-MAP Information Elements. In this way the relevance of the allocations in the succeeding DL-MAP Information Elements can be extended to future MAC frames.

Conditional DL Transmission Type
This parameter indicates the type of the condition to be checked in order to enable the scheduled transmissions in the following DL MAP. The possible values are:
   00—No condition
   01—Radio power at the receiver
   10—Reserved
   11—Reserved.

Max Power Level
This negative parameter indicates the max. power level (in dB) at which a transmission cannot be enabled.

The encoding of the remaining portions of the CX-DL-MAP message is PHY-specification dependent and may be absent.

The DL-MAP IEs in the CX-DL-MAP are sorted in an increasing order of the transmission start time of the relevant PHY burst. The transmission start time is conveyed by the contents of the DL_MAP IE in a manner that is PHY dependent.

Multiple CX-DL-MAP Messages are preferably transmitted and every CX-DL-MAP Message may use a different DIUC.

TABLE 3
CX-DL-MAP message format

| | Size | |
|---|---|---|
| Syntax | (bit) | Notes |
| DL-MAP_Message_Format( ) { | — | — |
| Management Message Type = 82 | 8 | — |
| PHY Synchronization Field | variable | See appropriate PHY |
| | | specification; may |
| | | include MAC Frame |
| | | Number. |
| if (WirelessMAN-CX) { | | |
| No. OFDMA symbols | | |
| } | | |
| DCD Count | 8 | — |
| Base Station ID | 48 | — |
| Begin PHY-specific section { | — | See applicable PHY |
| | | subclause. |
| if (WirelessMAN-OFDMA) { | — | — |
| No. OFDMA symbols | 8 | Number of OFDMA |
| | | symbols in the DL |
| } | — | subframe including all |
| | | AAS/ |
| for (i=1; i <= m; i++) { | | |
| for (j = 1; i <= n; j++) { | — | permutation zone. |
| DL MAC IE relevance | 4 | |
| Conditional DL transmission | 4 | 00 - no condition |
| type | | 01 - max. power level |
| if (Conditional DL | | — |
| transmission type = 001) { | | |
| Max power level | 8 | Negative value, in |
| | | dBm |
| } | | |
| DL-MAP_IE( ) | variable | — |
| } | | For each DL-MAP |
| | | element 1 to n |
| } | — | For each DL-MAP |
| | | element 1 to m. |
| } | — | See corresponding |
| | | PHY specification. |
| if !(byte boundary) { | — | — |
| Padding Nibble | 4 | — |
| } | — | — |
| } | — | Padding to reach byte |
| | | boundary. |

The logical order in which MPDUs are mapped to the PHY bursts in the DL is defined as the order of DL-MAP IEs in the DL-MAP message.

### CX-UL-MAP (UL Map) Message

The CX-DL-MAP message defines the access to the UL channel and has an extended scope and flexibility in comparison with the UL-MAP Message. The CX-UL-MAP message is shown in Table 4.

TABLE 4
CX-UL-MAP message format

| | Size | |
|---|---|---|
| Syntax | (bit) | Notes |
| UL-MAP_Message_Format( ) { | — | — |
| Management Message Type = 83 | 8 | — |
| Reserved | 8 | Shall be set to zero. |
| UCD Count | 8 | — |
| Begin PHY-specific section { | — | See applicable PHY |
| | | subclause. |
| if (WirelessMAN-OFDMA) { | — | — |
| No. OFDMA symbols | 8 | Number of OFDMA |
| | | symbols in the UL |
| } | — | Subframe |
| for (i=1; i <= m; i++) { | | |
| for (j = 1; i <= n; j++) { | — | permutation zone. |
| Allocation Start Time | 32 | — |
| Conditional UL transmission | 4 | 00 - no condition |
| type | | 01 - max. power |
| | | level |
| if (Conditional UL | | — |
| transmission type = 001) { | | |
| Max power level | 8 | Negative value, in |
| | | dBm |
| } | | |
| UL-MAP_IE( ) | variable | — |
| } | | For each UL-MAP |
| | | element 1 to n |
| } | — | For each UL-MAP |
| | | element 1 to m. |
| } | — | See corresponding |
| | | PHY specification. |
| if !(byte boundary) { | — | — |
| Padding Nibble | 4 | — |
| } | — | Padding to reach |
| | | byte boundary. |
| } | — | — |

The BS generates the CX-UL-MAP with the following parameters:

UCD Count

Matches the value of the Configuration Change Count of the UCD, which describes the UL burst profiles that apply to this map.

Allocation Start Time

Effective start time of the UL allocation defined by the UL-MAP (units are PHY-dependent). The Allocation Start Time may indicate allocations in subsequent MAC frames.

Map IEs

The contents of a UL-MAP IE is PHY-specification dependent.

Conditional UL Transmission Type

This parameter indicates the type of condition to be checked in order to enable scheduled transmissions in the following UL MAP. The possible values are:
00—No condition
01—Radio power at the receiver
10—Reserved
11—Reserved.

Max Power Level

This negative parameter indicates the max. power level (in dB) at which a transmission cannot be enabled.

IEs define UL bandwidth allocations. Each UL-MAP message (except when the PHY is an OFDMA PHY) contains at least one information element (IE) that marks the end of the last allocated burst. The sorting the IEs is carried out by the UL-MAP and is PHY-specific.

The CID represents the assignment of the IE to either a unicast, multicast, or broadcast address. When specifically addressed to allocate a bandwidth grant, the CID is the Basic CID of the SS. A UIUC is used to define the type of UL access and the UL burst profile associated with that access. An Uplink_Burst_Profile is included in the UCD for each UIUC to be used in the UL-MAP.

The logical order by which MPDUs are mapped to the PHY bursts in the UL is defined as the order of UL-MAP IEs in the UL-MAP message.

It is to be understood that the above description only includes some embodiments of the invention and serves for its illustration. Numerous other ways of managing a combination of different types of protocols in wireless telecommunication networks may be devised by a person skilled in the art without departing from the scope of the invention, and are thus encompassed by the present invention. Also, as will be appreciated by those skilled in the art, every such exemplified embodiment has different advantages and also applies to different implementation approaches, from combined scheduling to independent systems, using different communication procedures.

1. In a wireless communications network comprising at least one central station and a plurality of subscriber terminals associated therewith, out of which at least one of said subscriber terminals is operative to communicate by using a scheduled based protocol, a method for allowing communications between at least one central station and at least one subscriber terminal along a frequency communication channel, wherein the method comprises the steps of:
providing a plurality of time domain frames each comprising at least one first time interval adapted for communication with a subscriber terminal by applying a schedule based protocol, and at least one second time interval adapted for communication with a subscriber terminal by applying a contention based protocol;
scheduling a plurality of unconditioned transmissions for sending communications in a plurality of present and/or future frames during said first time interval of corresponding time domain frames to/from at least one subscriber terminal operative in accordance with said schedule based protocol;
scheduling a plurality of conditioned transmission opportunities for sending communications in a plurality of present and/or future frames during said second the interval of corresponding time domain frames to/from at least one subscriber terminal operative in accordance with said schedule based protocol;
determining, prior to sending a conditioned transmission in at least one second time interval of the at least one of the future frames, whether the value of received power level at that frequency communication channel is below a pre-defined threshold value; and
transmitting communications during the second time interval upon determining that the value of the received power level at that frequency communication channel does not exceed the value of the pre-defined threshold.

2. A method according to claim 1, further comprising a step of selecting at least one of said plurality of conditioned transmission opportunities for transmission of communications during a second time interval in at least one of said plurality of present and/or future frames.

3. A method according to claim 1, further comprising a step of determining whether additional transmission time would be required after having transmitted at least one communication message, and if in the affirmative, selecting another of said plurality of conditioned transmission opportunities for transmission of a communication message during a second time interval in at least one of the plurality of present and/or future frames.

4. A method according to claim 1, wherein said at least one subscriber terminal is adapted to transmit unconditioned transmissions during said first time interval and conditioned transmissions during said second time interval.

5. A method according to claim 1, wherein the step of scheduling a plurality of conditioned transmission opportunities comprises defining a starting point for conditioned transmissions using a random point in time during a contention window.

6. A method according to claim 5, wherein the length of said contention window intended for downlink transmission or for uplink transmission comprises the aggregated length of sub-frames intended for down-link transmissions or for uplink transmissions, respectively.

7. A method according to claim 5, further comprising a step of increasing the length of said contention window and/or delaying the beginning thereof, in response to an un-successful attempt to transmit a communication.

8. A method according to claim 5, wherein the conditioned transmission is selected so that it is in compliance with rules of downlink/up-link sub-frames applicable to the respective schedule base protocol transmissions.

9. A method according to claim 1, wherein the value of the pre-defined threshold is determined and/or modified by the central station or by an entity external to the system.

10. A method according to claim 1, wherein the value of the pre-defined threshold is determined/modified so as to adapt said value to the current frequency communication channel interference conditions.

11. A central station operative in a wireless communications network which comprises a plurality of subscriber terminals, out of which at least one subscriber terminal is operative to communicate with said central station by using a schedule based protocol, and wherein the central station comprises:
at least one radio transceiver operative at least one frequency and capable of transmitting and/or receiving both conditioned and un-conditioned transmissions along a frequency communication channel to/from the at least one subscriber terminal;
at least one processor adapted to schedule a plurality of conditioned and un-conditioned transmission and/or reception opportunities for communications in a plurality of future frames, to receive an input from energy level detection means as to the energy level in the respective frequency communication channel, to determine whether the energy level at that communication channel exceeds the value of a pre-defined threshold, and to enable transmissions to that at least one subscriber terminal along the respective communication channel if the energy level input does not exceed a pre-defined threshold value; and
energy level detection means operative to detect the energy level at that frequency communication channel along which communications are about to be transmitted, and to provide the value of the energy level detected to the at least one processor.

12. A central station according to claim 11, wherein said at least one subscriber terminal is operative to communicate with the central station by using a schedule based protocol, while transmitting/receiving both un-conditioned and conditioned communication, at the appropriate time interval.

13. A central station according to claim 11, wherein said at least one processor is further adapted to select at least one of said plurality of conditioned transmission opportunities for transmission of communications during a second time interval in at least one of said plurality of present and/or future frames.

14. A central station according to claim 11, wherein said at least one processor is further adapted to determine whether additional transmission time would be required after transmission of at least one communication message, and if in the affirmative, to select another of said plurality of conditioned transmission opportunities for transmission of a communication message during a second time interval in at least one of said plurality of present and/or future frames.

15. A central station according to claim 11, wherein said processor is further adapted to determine a starting point for possible communication transmissions and/or receptions using a random point in time during a time interval

16. A central station according to claim 11, wherein the value of the pre-defined threshold is determined and/or modified by said central station or by an entity external to the system.

17. A central station according to claim 11, wherein the value of the pre-defined threshold is determined and/or modified so as to adapt said value to the current frequency communication channel interference conditions.

18. A subscriber terminal operative in a wireless communications network to communicate with a central station by using schedule based protocol for transmitting and/or receiving both un-conditioned and conditioned transmissions, and wherein the subscriber terminal comprises:
at least one radio transceiver operative at least one frequency and capable of transmitting communication traffic towards the central station and receive communication traffic therefrom;
at least one processor adapted to:
receive information related to scheduling of a plurality of unconditioned transmissions for sending scheduled communications in at least one first time interval associated with a plurality of present and/or future frames;
receive information related to scheduling of a plurality of conditioned transmission opportunities for sending communications in at least one second time interval associated with a plurality of present and/or future frames;
receive an input from received power level detection means as to the received power level in the respective communication channel,
determine whether the received power level at that communication channel exceeds the value of a pre-defined threshold;
enable transmissions to the central station along the respective frequency communication channel if the energy level input does not exceed the pre-defined threshold value; and
received power level detection means operative to detect the received power level at the respective frequency communication channel along which communications are about to be transmitted, and to provide the value of the received power level detected to the at least one processor.

19. A subscriber terminal according to claim 18, wherein said at least one processor is further adapted to select at least one of said plurality of conditioned transmission opportunities for transmission of communications during a second time interval in at least one of said plurality of present and/or future frames.

20. A subscriber terminal according to claim 18, wherein said at least one processor is further adapted to determine whether additional transmission time would be required after transmission of at least one communication message, and if in the affirmative, to select another of said plurality of conditioned transmission opportunities for transmission of a communication message during a second time interval in at least one of said plurality of present and/or future frames.
